(19) United States
(12) Patent Application Publication
(10) Pub. No.: US 2021/0394588 A1
(43) Pub. Date: Dec. 23, 2021

(54) PACKING SEAL FOR A VEHICLE HVAC SYSTEM

(71) Applicant: DENSO International America, Inc., Southfield, MI (US)

(72) Inventor: Michael KULESZA-PINGER, Rochester, MI (US)

(21) Appl. No.: 16/903,555

(22) Filed: Jun. 17, 2020

(51) Int. Cl. B60H 1/34; B60H 1/00

(52) U.S. Cl. CPC B60H 1/3421; B60H 2001/00635; B60H 2001/3464; B60H 1/00528

(57) ABSTRACT

A seal includes a first segment and a second segment. The second segment has an outer periphery and defines a central orifice. The second segment also has first, second, third, and fourth living hinges. The first and second living hinges are formed between the outer periphery and the central orifice. The first and second living hinges are disposed on opposing sides of the central orifice. The third and fourth living hinges are formed between the outer periphery and the central orifice. The third and fourth living hinges are disposed on opposing sides of the central orifice. The second segment is configured to be adjusted about the first, second, third, and fourth living hinges such that the second segment forms a plurality of spokes extending outward from a central hub.

### TECHNICAL FIELD

The present disclosure relates to vehicle heating, ventilation, and air conditioning (HVAC) systems.

### BACKGROUND

Vehicle HVAC systems may include one or more heat exchangers that are configured to condition air that is being delivered to a vehicle cabin. Vehicle HVAC systems may also include a series of ducts that are configured to route the conditioned air from the heat exchangers to various outlets within the vehicle cabin.

### SUMMARY

A vehicle HVAC system includes a housing, an outlet, and a seal. The outlet is secured to the housing. The seal is disposed between the outlet and the housing. The seal is constructed from a plurality of segments. A first of the segments is configured to transition between first and second shapes. The first shape defines a central orifice; defines a first notch having first and second internal surfaces; defines a second notch on an opposing side of the central orifice from the first notch, the second notch having third and fourth internal surfaces; defines a first slit; and defines a second slit on an opposing side of the central orifice from the first slit. The second shape has a central hub and a plurality of spokes extending from the central hub. When the first of the segments is transitioned to the second shape, the first notch is collapsed such that the first and second internal surfaces contact each other, and the second notch is collapsed such that the third and fourth internal surfaces contact each other.

A seal that is configured to provide a seal between a vent outlet and an HVAC housing of a vehicle includes a foam block. The foam block defines a central orifice. The foam block defines first and second notches on first and second opposing sides of the central orifice such that first and second living hinges are formed on the first and second opposing sides of the central orifice between the first and second notches and the central orifice, respectively. The foam block defines first and second slits on third and fourth opposing sides of the central orifice, respectively, such that third and fourth living hinges are formed on the third and fourth opposing sides of the central orifice between the first and second slits and the central orifice, respectively. The foam block is configured to be adjusted about the first, second, third, and fourth living hinges such that the foam block forms a plurality of spokes extending outward from a central hub.

A seal includes a first segment and a second segment. The second segment has an outer periphery and defines a central orifice. The second segment also has first, second, third, and fourth living hinges. The first and second living hinges are formed between the outer periphery and the central orifice. The first and second living hinges are disposed on opposing sides of the central orifice. The third and fourth living hinges are formed between the outer periphery and the central orifice. The third and fourth living hinges are disposed on opposing sides of the central orifice. The second segment is configured to be adjusted about the first, second, third, and fourth living hinges such that the second segment forms a plurality of spokes extending outward from a central hub.

### BRIEF DESCRIPTION OF THE DRAWINGS

FIG. 1 is a schematic representation of a vehicle having an HVAC module;

FIG. 2 is a fragmented perspective view of an automotive vehicle showing a portion of the passenger space or cabin;

FIG. 3 is a cross-sectional view of the HVAC module;

FIG. 4 is an exploded view illustrating a portion of an HVAC housing, vent outlets, and a packing seal that is disposed between the HVAC housing and the vent outlets;

FIG. 5 is an example of a packing seal that is constructed from multiple segments, including at least one the segment that is configured to transition between two shapes; and

FIG. 6 is a block or segment that is configured to transition between two shapes and may be utilized to construct a portion of a packing seal.

### DETAILED DESCRIPTION

Embodiments of the present disclosure are described herein. It is to be understood, however, that the disclosed embodiments are merely examples and other embodiments may take various and alternative forms. The figures are not necessarily to scale; some features could be exaggerated or minimized to show details of particular components. Therefore, specific structural and functional details disclosed herein are not to be interpreted as limiting, but merely as a representative basis for teaching one skilled in the art to variously employ the embodiments. As those of ordinary skill in the art will understand, various features illustrated and described with reference to any one of the figures may be combined with features illustrated in one or more other figures to produce embodiments that are not explicitly illustrated or described. The combinations of features illustrated provide representative embodiments for typical applications. Various combinations and modifications of the features consistent with the teachings of this disclosure, however, could be desired for particular applications or implementations.

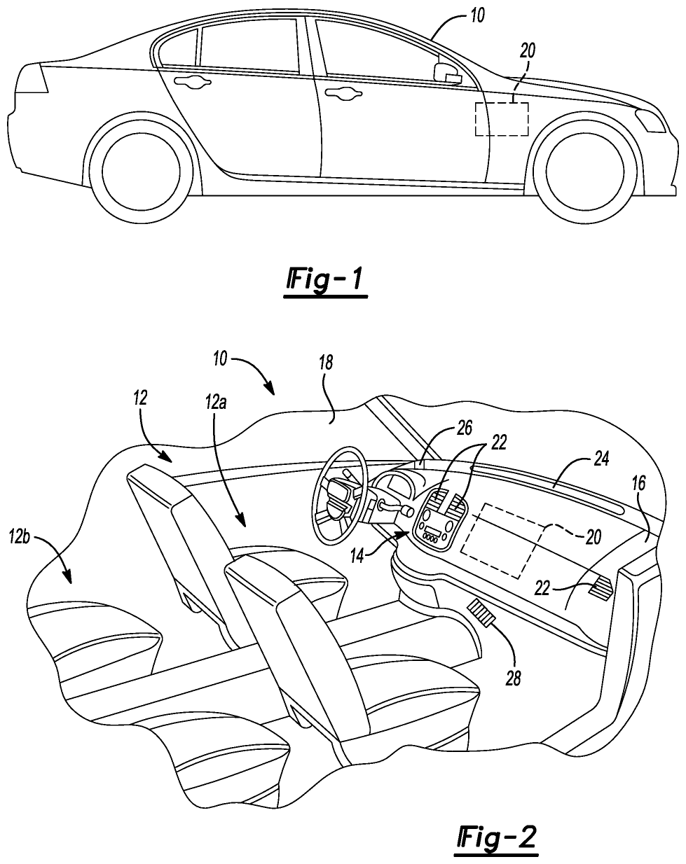

Referring to FIGS. 1 and 2, a vehicle 10 having an HVAC module, casing, or housing 20 is illustrated. The HVAC module 20 is part of the HVAC system and/or ventilation system of the vehicle and therefore may be referred to as a vehicle HVAC module 20. The vehicle 10 includes a passenger space or vehicle cabin 12, which may include both a front passenger space 12a and a rear passenger space 12b. HVAC controls 14 allow for adjustment of the operation of HVAC module 20 to provide desired flows and/or conditioning of air that is being delivered to the vehicle cabin 12. The vehicle 10 may include an instrument panel (IP) or dashboard 16 that may have a series of outlets that are fluidly connected to the HVAC module 20. More specifically, the dashboard may contain center face vent outlets 22, a windshield defrost vent outlet 24, and demist vent outlets 26 that are used to direct airflow to the side windows 18 of the vehicle 10. The demist vent outlets 26 may also be referred to as the side window demist vent outlets. The demist vent outlets 26 may be on the top of the dashboard 16 or the side of the dashboard 16. The vehicle cabin 12 may also contain floor vent outlets 28 that direct airflow toward a passenger's feet. It should be understood that the vehicle 10 and HVAC module 20 depicted in FIGS. 1 and 2 are for illustrative purposes only and that the disclosure should not be construed as limited to the vehicle 10 and HVAC module 20 depicted in FIGS. 1 and 2.

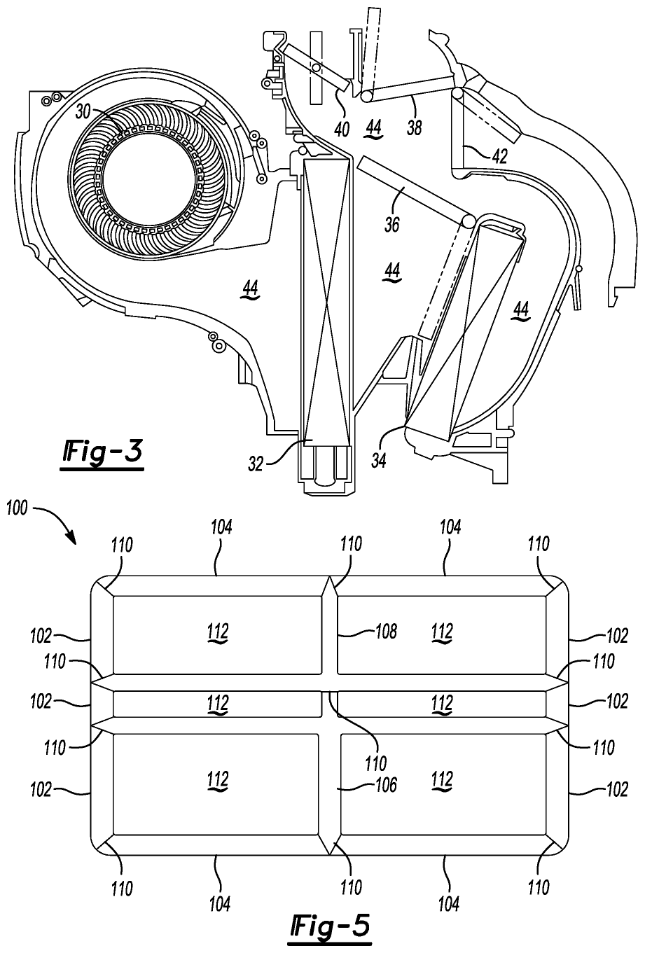

Referring to FIG. 3, a cross-section of the HVAC module 20 is shown. The HVAC module 20 includes a blower fan 30, which may be referred to as a blower or an airflow generator. Downstream of the blower fan 30 is an evaporator 32 or first heat exchanger, which may be part of a refrigeration system that is configured to cool the air before delivering the air to the vehicle cabin 12. Also downstream of the blower fan 30 is a heater core 34, or second heat exchanger, that is used to heat the air before delivering the air to the vehicle cabin 12. An air mix door 36 may be used to determine the ratio of the air that flows through the heater core 34 relative to the air that flows around or bypasses the heater core 34. To control the air flow of through the HVAC module 20 based on an air mode that has been selected by the vehicle operator via the HVAC controls 14, a series of vent doors may control the amount of air flowing out of the face vent outlets 22, the windshield defrost vent outlet 24, the demist vent outlets 26, and/or the floor vent outlets 28. Door 38 controls the airflow directed to the face vent outlets 22, known as the face door 38. Door assembly 40, controls airflow directed to the defrost vent outlet 24 and demist vent outlets 26. Door 42 controls the airflow directed to the floor vent outlets 28. The HVAC module 20 may define a plurality of channels or chambers 44 that are configured to direct airflow from the blower fan 30 to a least one outlet (i.e., the face vent outlets 22, the windshield defrost vent outlet 24, the demist vent outlets 26, and/or the floor vent outlets 28).

It should be understood that the HVAC module 20 depicted in FIG. 3 is for illustrative purposes only and that the disclosure should not be construed as limited to the HVAC module 20 depicted in FIG. 3. For example, the positioning of the doors (i.e., doors 36, 38, 40, and 42) may be different, the number of doors utilized may be different than illustrated, the positioning of the blower fan 30, evaporator 32, or heater core 34 may be different than illustrated, the types of doors utilized may different that illustrated, the positioning of the channels or chambers 44 that are utilized route the air through the HVAC module may be different than illustrated, etc. Furthermore, each of the doors may be transitioned between the various positions by an actuator such as an electric motor, a pneumatic cylinder, etc. The actuator may be directly connected to the door (e.g., an electric motor may be connected to a pivot shaft of the door) or may be indirectly connected to the door via gears, shafts, linking arms, etc.

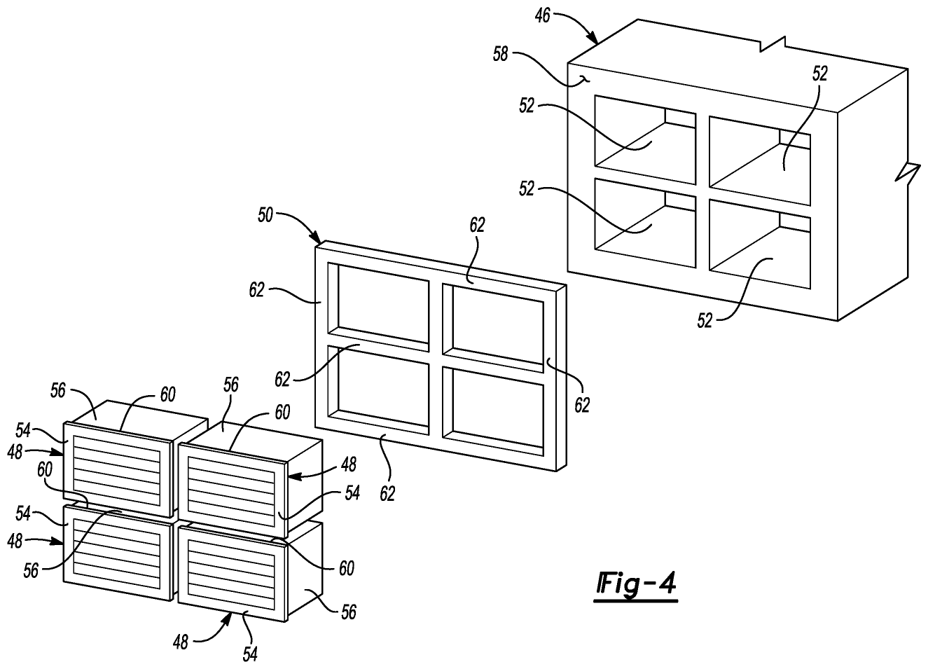

Referring to FIG. 4, an exploded view of a portion of an HVAC housing 46, vent outlets 48, and a packing seal 50 that is disposed between the HVAC housing 46 and the vent outlets 48 is illustrated. The HVAC housing 46 may be a portion or extension of an HVAC module (e.g., HVAC module 20). The HVAC housing 46 defines ducts or channels 52 that are configured to direct conditioned air (i.e., air that has been heated or cooled) into a cabin of a vehicle (e.g., vehicle cabin 12) via the vent outlets 48.

Each of the vent outlets 48 may include a front plate 54 and a tube 56 that extends from the font plate 54. Each front plate 54 defines an opening that is configured to expel the conditioned air from the channels 52 into the vehicle cabin. Each tube 56 defines a channel that establishes fluid communication between the opening in the front plate 54 and one of the channels 52 in the HVAC housing 46. Adjustable louvers may be disposed in the opening of the front plate 54 of each vent outlet 48. An operator of the vehicle or a passenger may adjust the position of the louvers to redirect the air flow being expelled into the vehicle cabin. The HVAC housing 46 may include an exterior surface 58. The tubes 56 of each vent outlet 48 are disposed within one of the channels 52 of the HVAC housing 46.

The packing seal 50 is disposed between a back surface 60 of each front plate 54 and the exterior surface 58 of the HVAC housing 46 to prevent internal air leaks and to ensure air is directed from the channels 52 into the vehicle cabin via the vent outlets 48. The packing seal 50 includes several segments 62. The packing seal 50 may be made from a sealing material such as, but not limited to, Foam Ether Polyurethane (FETU), Foam Ester Polyurethane (FESU), Ethylene Propylene Diene Monomer (EPDM), Foam Polyethylene (FPE), etc. The packing seal 50 may be configured to form a seal between a plurality of channels 52 defined in the HVAC module 46 and a plurality of the vent outlets 48. It should be understood however, that the configuration in FIG. 4 is for illustrative purposes only and the that the number, position, and configuration of the channels 52 in the HVAC module, the vent outlets 48, and packing seal 50 may be adjusted to accommodate any configuration that includes one or more vent outlets 48.

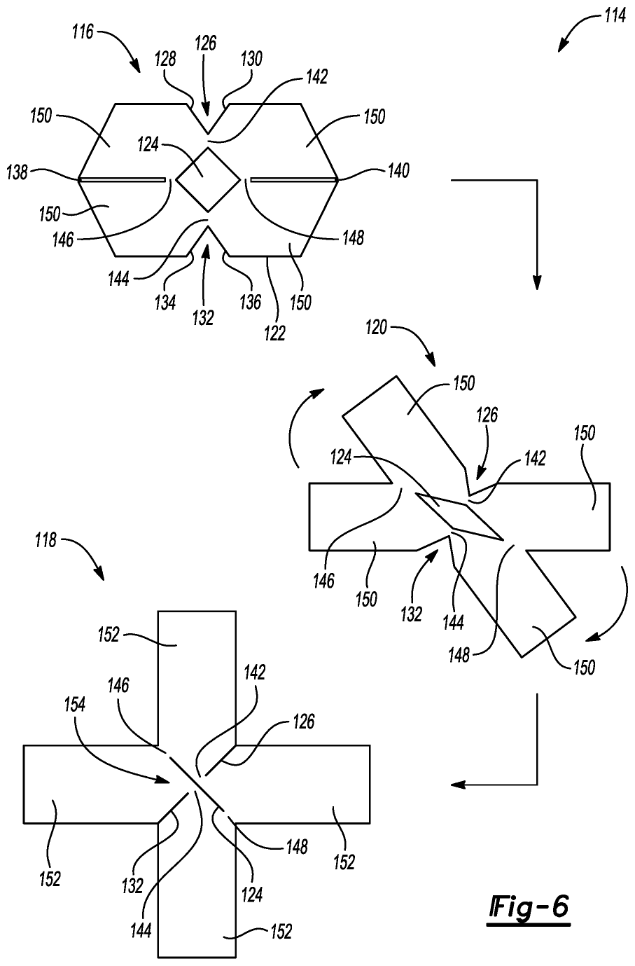

Referring to FIG. 5, an example of a packing seal 100 that is constructed from multiple segments is illustrated. The packing seal 100 may be utilized between an HVAC housing and a vent outlet as described above. The packing seal 100 and each segment of the packing seal 100 may be made from a sealing material such as, but not limited to, FETU, FESU, EPDM, FPE, etc. The packing seal 100 includes a first plurality of segments 102 that are arranged vertically with respect to FIG. 5. The packing seal 100 includes a second plurality of segments 104 that are arranged horizontally with respect to FIG. 5. The packing seal 100 includes a first intermediate segment 106 and a second intermediate segment 108.

The first intermediate segment 106 and the second intermediate segment 108 are each disposed between the segments from the first and second plurality of segments 102, 104. The segments from the first plurality of segments 102, the second plurality of segments 104, the first intermediate segment 106, and the second intermediate segment 108 are interconnected via a series of joints 110 to form an array of openings 112. An adhesive or any other joining method may be utilized at each joint 110 to connect adjacent segments. Alternatively, the segments 102, 104, 106, and 108 may not be directly attached to each other, but may be attached separately to the exterior surface 58 of the HVAC housing 46 via an adhesive or other joining method. If the segments 102, 104, 106, and 108 are attached separately to the exterior surface 58 of the HVAC housing 46, the adjacent segments may abut against each other along the joints 110 once they have been attached to the exterior surface 58 of the HVAC housing 46. Each segment that forms a periphery around a single opening of the arrays of openings 112 may be utilized to form seal between two components (e.g., one of the channels 52 in the HVAC housing 46 and one of the vent outlet 48). The first intermediate segment 106 is shown to be cross-shaped while the second intermediate segment 108 is shown to be T-shaped. The first intermediate segment 106 and the second intermediate segment 108 may be configured to transition between two shapes, which is described in further detail with respect to FIG. 6. Although the packing seal 100 illustrated in FIG. 5 includes two intermediate components and forms 6 openings, it should be understood that the packing seal 100 may include segments that include one or more intermediate segments and that the packing seal 100 may form one or more openings.

Referring to FIG. 6, a block or segment 114 that is configured to transition between two shapes is illustrated. The segment 114 may be utilized to construct a portion of a packing seal (e.g., packing seal 50 or packing seal 100). More specifically, the segment 114 may be utilized to form an intermediate component (e.g., first intermediate segment 106 or second intermediate segment 108) of a packing seal. The segment 114 is configured to transition between a first shape 116 and a second shape 118. An intermediate position 120 is illustrated between the first shape 116 and the second shape 118.

The required function of a packing seal may require the construction of a segment according to the second shape 118. However, the first shape 116 is much more compact relative to the second shape 118. Since the first shape 116 is more compact than the second shape 118, constructing the segment 114 according to the first shape 116, decreases the amount of scrap material, and therefore decreases material costs, that results from producing the segment 114, particularly when the segment 114 is cut from a stock sheet of material via a die. Therefore, it may be ideal to construct the segment 114 according to the first shape 116 to minimize scrap material and decrease the cost of producing the segment 114.

When the segment 114 is oriented to form the first shape 116, the segment 114 has an outer periphery 122; defines a central orifice 124; defines a first notch 126 having a first internal surface 128 and a second internal surface 130; and defines a second notch 132 on an opposing or opposite side of the central orifice 124 relative to the first notch 126. The second notch 132 has a third internal surface 134 and a fourth internal surface 136. The central orifice 124 may be square-shaped or diamond-shaped. When the segment 114 is oriented to form the first shape 116, the segment 114 defines a first slit 138 and a second slit 140. The second slit 140 is on an opposing or opposite side of the central orifice 124 relative to the first slit 138.

A first living hinge 142 and a second living hinge 144 are formed on first and second opposing or opposite sides of the central orifice 124, respectively. A living hinge is a thin flexible hinge (flexure bearing) made from the same material as the two pieces it connects. It is typically thinned or cut to allow the rigid pieces to bend along the line of the hinge. The first living hinge 142 is formed between the outer periphery 122 and the central orifice 124. More specifically, the first living hinge 142 is formed between first notch 126 and the central orifice 124. The second living hinge 144 is also formed between the outer periphery 122 and the central orifice 124. More specifically, the second living hinge 144 is formed between the second notch 132 and the central orifice 124. The first living hinge 142 and the second living hinge 144 may be arranged about the central orifice 124 relative to each other at an angle that is substantially 180°. Substantially 180° may refer to any incremental angle between 170° and 190°.

A third living hinge 146 and a fourth living 148 hinge are formed on third and fourth opposing sides of the central orifice 124, respectively. The third living hinge 146 is formed between the outer periphery 122 and the central orifice 124. More specifically, the third living hinge 146 is formed between the first slit 138 and the central orifice 124. The fourth living hinge 148 is formed between the outer periphery 122 and the central orifice 124. More specifically, the fourth living hinge 148 is formed between the second slit 140 and the central orifice 124. The third living hinge 146 and the fourth living hinge 148 may be arranged about the central orifice 124 relative to each other at an angle that is substantially 180°. Substantially 180° may refer to any incremental angle between 170° and 190°.

The first living hinge 142 may be arranged about the central orifice 124 relative to the third living hinge 146 and/or the fourth living hinge 148 at an angle that is substantially perpendicular. The second living hinge 144 may also be arranged about the central orifice 124 relative to the third living hinge 146 and/or the fourth living hinge 148 at an angle that is substantially perpendicular. Substantially perpendicular may refer to any incremental angle that is between 80° and 100°.

The segment 114 may be adjusted about the first living hinge 142, second living hinge 144, third living hinge 146, and fourth living hinge 148 to transition between the first shape 116 and the second shape 118 (i.e., sub-portions 150 of the segment 114 may be rotated about the living hinges 142, 144, 146, 148 as illustrated at the intermediate position 120 to transition between the first shape 116 and the second shape 118). When the segment 114 is transitioned to the second shape 118, the segment 114 forms a plurality of spokes 152 that extend outward from a central hub 154. The spokes 152 may be comprised of the sub-portions 150 that were rotated about the living hinges 142, 144, 146, 148. The plurality of spokes 152 and central hub 154 may form a cross-shape as illustrated in FIG. 6. Alternatively, one of the spokes 152 may be cut down such that the plurality of spokes 152 and central hub 154 may form a T-shape (e.g., see second intermediate segment 108 in FIG. 5). When the segment 114 is transitioned from the first shape 116 to the second shape 118, the first notch 126 is collapsed such that the first internal surface 128 and the second internal surface 130 contact each other, the second notch 132 is collapsed such that the third internal surface 134 and the fourth internal surfaces 136 contact each other, and the central orifice 124 closes.

It should be understood that the designations of first, second, third, fourth, etc. for channels, outlets, segments, living hinges, notches, slits, shapes, sides or any other component, state, or condition described herein may be rearranged in the claims so that they are in chronological order with respect to the claims.

The words used in the specification are words of description rather than limitation, and it is understood that various changes may be made without departing from the spirit and scope of the disclosure. As previously described, the features of various embodiments may be combined to form further embodiments that may not be explicitly described or illustrated. While various embodiments could have been described as providing advantages or being preferred over other embodiments or prior art implementations with respect to one or more desired characteristics, those of ordinary skill in the art recognize that one or more features or characteristics may be compromised to achieve desired overall system attributes, which depend on the specific application and implementation. As such, embodiments described as less desirable than other embodiments or prior art implementations with respect to one or more characteristics are not outside the scope of the disclosure and may be desirable for particular applications.

What is claimed is:

1. A vehicle HVAC system comprising:
a housing;
an outlet secured to the housing; and
a seal disposed between the outlet and the housing, the seal constructed from a plurality of segments, wherein a first of the segments is configured to transition between:
a first shape
defining a central orifice,
defining a first notch having first and second internal surfaces,
defining a second notch on an opposing side of the central orifice from the first notch, the second notch having third and fourth internal surfaces,
defining a first slit, and
defining a second slit on an opposing side of the central orifice from the first slit, and
a second shape having a central hub and a plurality of spokes extending from the central hub, wherein in the second shape the first notch is collapsed such that the first and second internal surfaces contact each other, and the second notch is collapsed such that the third and fourth internal surfaces contact each other.

2. The vehicle HVAC system of claim 1, wherein the central orifice is configured to close as the first of the segments transitions from the first shape to the second shape.

3. The vehicle HVAC system of claim 1, wherein the plurality of spokes and the central hub form a cross-shape.

4. The vehicle HVAC system of claim 1, wherein the plurality of spokes and the central hub form a T-shape.

5. The vehicle HVAC system of claim 1, wherein first and second living hinges are formed between the first and second notches and the central orifice, respectively, third and fourth living hinges are formed between the first and second slits and the central orifice, respectively, and the first of the segments is configured to be adjusted about the first, second, third, and fourth living hinges to transition between the first and second shapes.

6. The vehicle HVAC system of claim 5, wherein the first and third living hinges are arranged about the central orifice relative to each other at an angle that is substantially perpendicular.

7. The vehicle HVAC system of claim 5, wherein the second and fourth living hinges are arranged about the central orifice relative to each other at an angle that is substantially perpendicular.

8. A seal that is configured to provide a seal between a vent outlet and HVAC housing of a vehicle, the seal comprising:
a foam block, the foam block
defining a central orifice,
defining first and second notches on first and second opposing sides of the central orifice such that first and second living hinges are formed on the first and second opposing sides of the central orifice between the first and second notches and the central orifice, respectively, and
defining first and second slits on third and fourth opposing sides of the central orifice, respectively, such that third and fourth living hinges are formed on the third and fourth opposing sides of the central orifice between the first and second slits and the central orifice, respectively, wherein the foam block is configured to be adjusted about the first, second, third, and fourth living hinges such that the foam block forms a plurality of spokes extending outward from a central hub.

9. The seal of claim 8, wherein the plurality of spokes and the central hub form a cross-shape.

10. The seal of claim 8, wherein the plurality of spokes and the central hub form a T-shape.

11. The seal of claim 8, wherein the central orifice is square-shaped.

12. The seal of claim 8, wherein the first and second living hinges are arranged about the central orifice relative to each other at an angle that is substantially 180°.

13. The seal of claim 8, wherein the third and fourth living hinges are arranged about the central orifice relative to each other at an angle that is substantially 180°.

14. The seal of claim 8, wherein the first and third living hinges are arranged about the central orifice relative to each other at an angle that is substantially perpendicular.

15. The seal of claim 8, wherein the second and fourth living hinges are arranged about the central orifice relative to each other at an angle that is substantially perpendicular.

16. A seal comprising:
a first segment; and
a second segment, the second segment
having an outer periphery,
defining a central orifice,
having first and second living hinges formed between the outer periphery and the central orifice and disposed on opposing sides of the central orifice, and
having third and fourth living hinges formed between the outer periphery and the central orifice and disposed on opposing sides of the central orifice, wherein the second segment is configured to be adjusted about the first, second, third, and fourth living hinges such that the second segment forms a plurality of spokes extending outward from a central hub.

17. The seal of claim 16, wherein the plurality of spokes and the central hub form a cross-shape.

18. The seal of claim 16, wherein the plurality of spokes and the central hub form a T-shape.

19. The seal of claim 16, wherein the first and third living hinges are arranged about the central orifice relative to each other at an angle that is substantially perpendicular.

20. The seal of claim 16, wherein the second and fourth living hinges are arranged about the central orifice relative to each other at an angle that is substantially perpendicular.
